(19) United States
(12) Patent Application Publication
(10) Pub. No.: US 2025/0392164 A1
(43) Pub. Date: Dec. 25, 2025

(54) PORTABLE CHARGING TERMINAL

(71) Applicant: TOYODA GOSEI CO., LTD., Kiyosu-shi (JP)

(72) Inventors: Tsubasa SUZUKI, Kiyosu-shi (JP); Atsushi SUGIHARA, Kiyosu-shi (JP); Hideki SEKI, Kiyosu-shi (JP); Yuki TOKUYAMA, Kiyosu-shi (JP); Tomokazu SAKAI, Kiyosu-shi (JP); Shinichiro FUKI, Kiyosu-shi (JP)

(21) Appl. No.: 19/231,909

(22) Filed: Jun. 9, 2025

(30) Foreign Application Priority Data
Jun. 25, 2024 (JP) 2024-102258

(51) Int. Cl. H02J 50/00; H01Q 9/04; H01Q 21/06; H02J 7/00; H02J 50/10; H02J 50/27; H02J 50/80

(52) U.S. Cl. CPC H02J 50/005; H01Q 9/0492; H01Q 21/061; H02J 7/0042; H02J 50/10; H02J 50/27; H02J 50/80

(57) ABSTRACT

A portable charging terminal includes a case, a power storage device, a charging interface, and a substrate. The case includes a power receiving wall and a charging wall. The power receiving wall and the charging wall define two planes of the case that face each other. The charging interface is configured to supply power from the power storage device to an external terminal. A power receiving antenna and a power receiving circuit are disposed on the substrate. The power storage device and the charging interface are arranged facing the charging wall. The substrate is arranged so that the power receiving antenna faces the power receiving wall. The power receiving antenna includes a circular polarized antenna element.

### CROSS-REFERENCE TO RELATED APPLICATIONS

This application is based upon and claims the benefit of priority from prior Japanese Patent Application No. 2024-102258, filed on Jun. 25, 2024, the entire contents of which are incorporated herein by reference.

### BACKGROUND

### 1. Field

The present disclosure relates to a portable charging terminal.

### 2. Description of Related Art

Japanese Patent No. 6725531 discloses a wirelessly chargeable battery apparatus of a dry cell type. The wirelessly chargeable battery apparatus described in the publication includes an antenna that receives wireless radio frequency (RF) electric power, an electronic circuit board that converts the received wireless RF electric power into DC power, and a battery module that stores the DC electric power.

A portable charging terminal includes the antenna, the electronic circuit board, and the battery module, which are described above, and a charging interface that supplies an external terminal with electric power from the charged battery module. The portable charging terminal is used to charge, for example, an external terminal such as a multifunctional portable device incorporating a dedicated battery.

If antenna gain of the portable charging terminal is increased, a power storage device incorporated in the portable charging terminal is more efficiently charged.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a portable charging terminal includes a case, a power storage device, a charging interface, and a substrate. The case includes a power receiving wall and a charging wall. The power receiving wall and the charging wall define two planes of the case that face each other. The charging interface is configured to supply electric power from the power storage device to an external terminal. A power receiving antenna disposed on the substrate is configured to receive electric power supplied to the power storage device, and a power receiving circuit disposed on the substrate is configured to charge the power storage device with electric power from the power receiving antenna. The power storing device and the charging interface are arranged facing the charging wall. The substrate is arranged so that the power receiving antenna faces the power receiving wall, and the power receiving antenna includes a circular polarized antenna element.

Other features and aspects will be apparent from the following detailed description, the drawings, and the claims.

### BRIEF DESCRIPTION OF THE DRAWINGS

FIG. 1 is a perspective view illustrating how a portable charging terminal in accordance with a first embodiment is used.

FIG. 2 is a block diagram of the portable charging terminal.

FIG. 3 is a cross-sectional view taken along line 3-3 in FIG. 1.

FIG. 4 is a cross-sectional view taken along line 4-4 in FIG. 3.

FIG. 5 is a plan view showing a first main surface of a substrate.

FIG. 6 is a plan view showing a second main surface of the substrate.

FIG. 7 is a plan view showing the structure of a circular polarized antenna element.

FIG. 8 is a plan view showing the structure of a linear polarized antenna element.

FIG. 9 is a cross-sectional view of the substrate.

FIG. 10 is a cross-sectional view of a portable charging terminal in accordance with a second embodiment.

FIG. 11 is a schematic plan view showing a first main surface of a substrate in the second embodiment.

FIG. 12 is a cross-sectional view of a portable charging terminal in accordance with a third embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

### First Embodiment

A first embodiment will now be described with reference to the drawings.

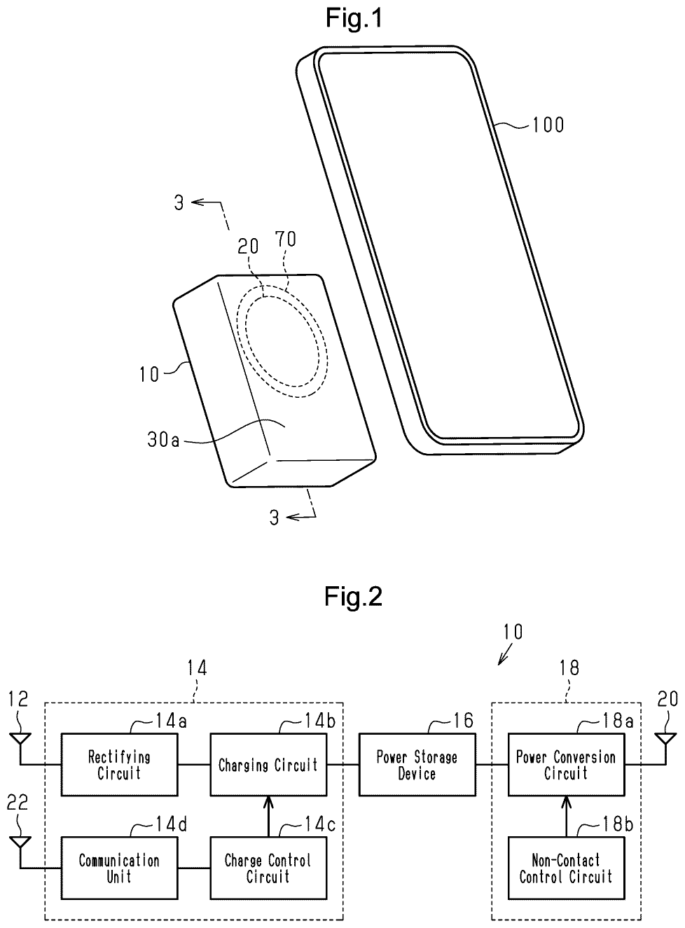

As shown in FIG. 1, a portable charging terminal 10 is a portable battery that supplies electric power to an external terminal 100 in a non-contact manner. The external terminal 100 is, for example, a multifunctional portable terminal such as a multifunctional portable phone.

### Basic Structure of the Portable Charging Terminal

As shown in FIG. 2, the portable charging terminal 10 includes a power receiving antenna 12, a power receiving circuit 14, a power storage device 16, and a non-contact charging device 18.

The power receiving antenna 12 receives electric power from an external power supplying device (not shown). More specifically, the electric power from an external device is transmitted by microwaves. The microwaves may be in a frequency band of 5.7 to 5.8 GHz. More specifically, the frequency band of the microwaves may be, for example, 5.75 GHz. The frequency band of the microwaves may be, for example, 5.8 GHz. The frequency band of the microwaves may be, for example, 24 GHz. The electric power received by the power receiving antenna 12 is input to the power receiving circuit 14.

The power receiving circuit 14 includes rectifying circuits 14a, a charging circuit 14b, a charge control circuit 14c, and a communication unit 14d. The rectifying circuits 14a convert the alternating current (AC) electric power received by the power receiving antenna 12 into direct current (DC) electric power. The charging circuit 14b charges the power storage device 16 with the DC electric power output from the rectifying circuits 14a. The charge control circuit 14c operates the charging circuit 14b to control the amount of power charged to the charging amount the power storage device 16.

The communication unit 14d communicates with the portable charging terminal 10 through the communication antenna 22. The communication unit 14d transmits, for example, an identification signal of the portable charging terminal 10 to an external device through the communication antenna 22. Thus, the portable charging terminal 10 acts as a beacon. The transmission of the identification signal allows the power supplying device to recognize the presence of the portable charging terminal 10. The power supplying device wirelessly transmits electric power on a condition that the presence of the portable charging terminal 10 is detected. The communication unit 14d may also be configured to exchange information with the power supplying device on the amount of electric power supplied.

The power storage device 16 is, for example, a rechargeable battery. Examples of a rechargeable battery include a lithium-ion battery and a nickel-metal hydride battery. The power storage device 16 is not limited to a rechargeable battery and may be, for example, a capacitor.

The non-contact charging device 18 is an electromagnetic induction-type charging circuit that supplies the electric power of the power storage device 16 to an external device through a coil 20 acting as a charging interface. The non-contact charging device 18 includes a power conversion circuit 18a and a non-contact control circuit 18b. The power conversion circuit 18a supplies the electric power of the power storage device 16 to the coil 20. The non-contact control circuit 18b operates the power conversion circuit 18a to control the amount of electric power supplied to an external device.

### Layout of the Portable Charging Terminal

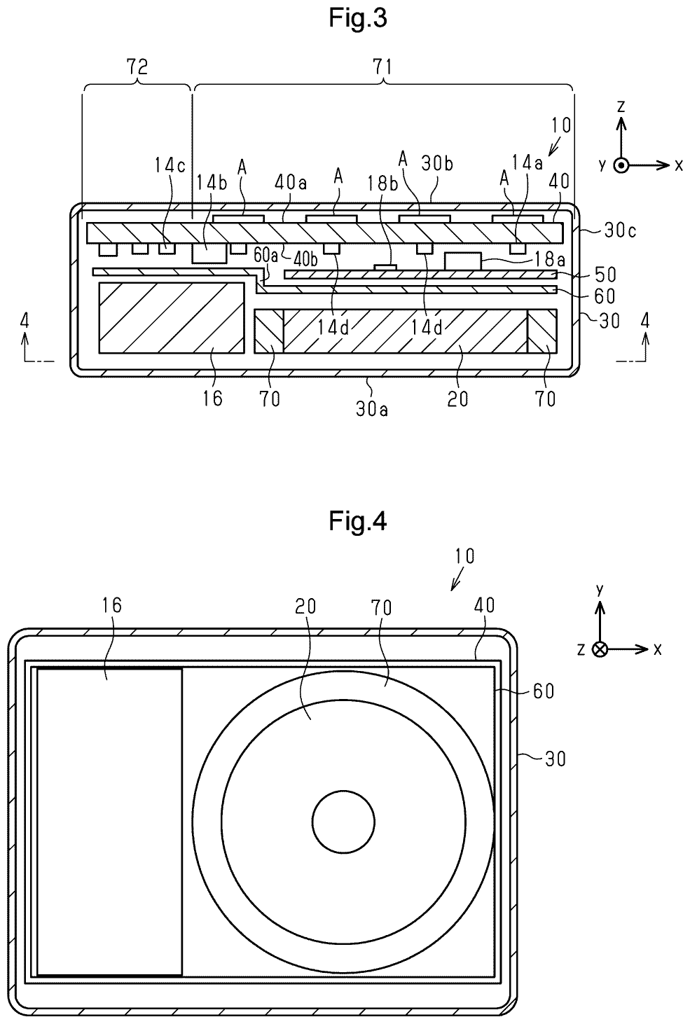

As shown in FIG. 3, the portable charging terminal 10 includes a box-shaped case 30. The case 30 includes a charging wall 30a and a power receiving wall 30b, which are spaced apart from each other, and peripheral walls 30c, which connect the charging wall 30a and the power receiving wall 30b. The case 30 is, for example, a rectangular parallelepiped. The illustrated case 30 is, for example, a rectangular parallelepiped having a low profile. In this case, for example, the two rectangular planes having the largest area among the six planes of the rectangular parallelepiped define the charging wall 30a and the power receiving wall 30b.

With respect to the charging wall 30a and the power receiving wall 30b, an axis extending parallel to the long sides is referred to as “the x-axis,” an axis extending parallel to the short sides is referred to as “the y-axis.” An axis extending orthogonal to both the x-axis and the y-axis is defined as “the z-axis.” Thus, the charging wall 30a and the power receiving wall 30b have sides parallel to the x-axis and the y-axis, and the charging wall 30a and the power receiving wall 30b are spaced apart from each other in the z-axis.

The charging wall 30a defines a negative z-axis surface of the portable charging terminal 10. The power storage device 16, the coil 20, and a magnet 70 are arranged facing the charging wall 30a in the case 30. The magnet 70 is used to fix the portable charging terminal 10 to the external terminal 100, which is the subject supplied with electric power.

As shown in FIG. 4, the power storage device 16, the coil 20, and the magnet 70 are arranged in the x-axis direction, which is the longitudinal direction of the case 30. The magnet 70 surrounds the outer circumference of the coil 20.

As shown in FIG. 3, a substrate 40 is arranged facing the power receiving wall 30b in the case 30. The substrate 40 includes a first main surface 40a facing the power receiving wall 30b. The power receiving antenna 12 and the communication antenna 22 include circular polarized antenna elements A disposed on the first main surface 40a.

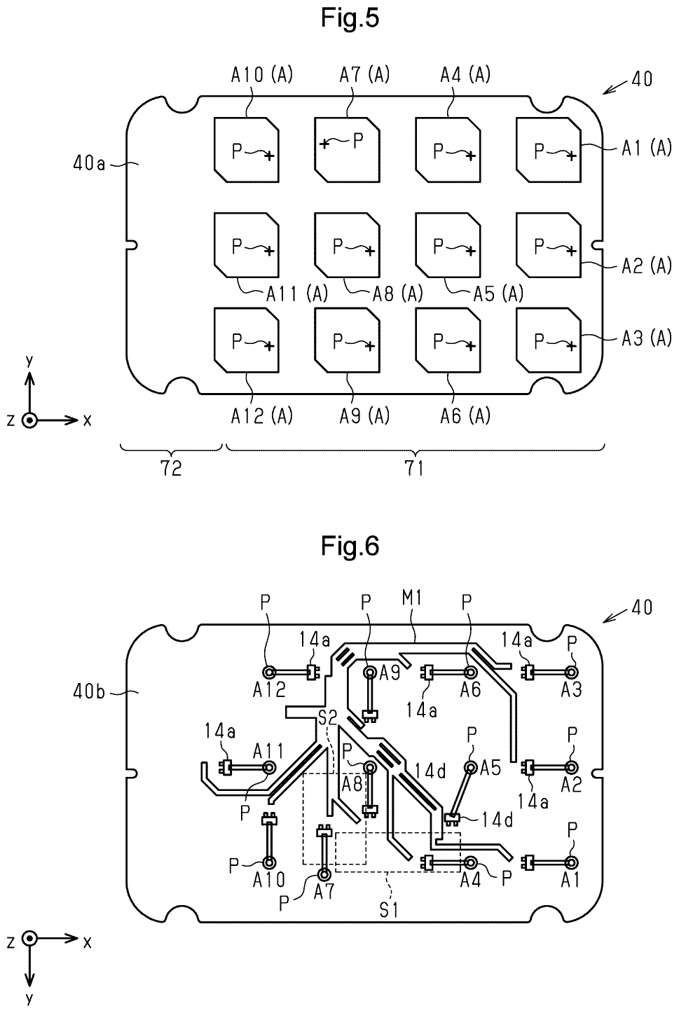

As shown in FIG. 5, the circular polarized antenna elements A are disposed on the first main surface 40a of the substrate 40. The first main surface 40a is divided into two regions in the x-axis direction, which is the longitudinal direction of the substrate 40. The circular polarized antenna elements A are disposed in a first region 71, which is one of the two regions. A second region 72, which is the other one of the two regions of the first main surface 40a, is a GND region where the circular polarized antenna element A are grounded.

In the present embodiment, there are twelve circular polarized antenna elements A, namely, circular polarized antenna elements A1 to A12. When referring to the x-axis direction as the longitudinal direction and the y-axis direction as the lateral direction, the circular polarized antenna elements A1 to A12 are disposed in columns, each including four polarized antenna elements arranged at constant intervals in the longitudinal direction, and rows, each including three polarized antenna elements arranged at constant intervals in the lateral direction. The structure of each circular polarized antenna element A will be described in detail later.

As shown in FIG. 3, the substrate 40 includes a second main surface 40b that is opposite the first main surface 40a. The rectifying circuits 14a and the communication unit 14d are disposed on the second main surface 40b. More specifically, the rectifying circuits 14a and the communication unit 14d are disposed on the second main surface 40b in a region onto which the circular polarized antenna elements A are projected at a right angle. In other words, the group of the x-axis components and the y-axis components of the region in which the rectifying circuits 14a are disposed is included in the group of the x-axis components and the y-axis components of the region in which the circular polarized antenna elements A are disposed.

The charging circuit 14b and the charge control circuit 14c are also disposed on the second main surface 40b of the substrate 40. The substrate 40 is divided in the x-axis direction, which is the longitudinal direction of the substrate 40, into two regions, that is, a region where the charging circuit 14b and the charge control circuit 14c are disposed and a region where the rectifying circuits 14a are disposed.

A charging substrate 50 is arranged in the case 30 facing the second main surface 40b of the substrate 40. The charging substrate 50 has a shorter length in the x-axis direction, which is the longitudinal direction, than the substrate 40. The charging substrate 50 is arranged facing the first region 71 of the substrate 40 where the rectifying circuits 14a are disposed. The power conversion circuit 18a and the non-contact control circuit 18b are disposed on the charging substrate 50.

A metal electromagnetic shield 60 is arranged in the case 30. The electromagnetic shield 60 partitions the case 30 into a region where the substrate 40 and the charging substrate 50 are accommodated and a region where the rechargeable battery, the coil 20, and the magnet 70 are accommodated.

As shown in FIG. 4, the substrate 40 includes a region onto which the electromagnetic shield 60 is projected at a right angle onto the substrate 40.

As shown in FIG. 3, the electromagnetic shield 60 includes a bent portion 60a near a boundary between a region facing the power storage device 16 and a region facing the coil 20 and the magnet 70. The bent portion 60a extends in a direction orthogonal to the electromagnetic shield 60. Thus, the bent portion 60a forms a step in the z-axis direction between the region facing the power storage device 16 and the region facing the coil 20 and the magnet 70.

In the electromagnetic shield 60, the region facing the power storage device 16 is located toward the positive side in the z-axis from the region facing the coil 20 and the magnet 70. This is because the power storage device 16 is thicker in the z-axis direction than the coil 20 and the magnet 70. Thus, the distance between the substrate 40 and the electromagnetic shield 60 is greater at the region where the electromagnetic shield 60 faces the charging substrate 50 than the region where the electromagnetic shield 60 does not face the charging substrate 50.

### Example of Use

As shown in FIG. 1, the portable charging terminal 10 supplies the external terminal 100 with electric power in a non-contact manner to charge the external terminal 100 in a non-contact manner. The charging wall 30a of the portable charging terminal 10 is arranged facing the external terminal 100. FIG. 1 shows a state in which the portable charging terminal 10 is separated from the external terminal 100. However, when actually charging the external terminal 100, the charging wall 30a of the portable charging terminal 10 may be in contact with the external terminal 100.

In a state in which the external terminal 100 is attracted to the portable charging terminal 10 by the magnet 70, the coil 20 and a power reception coil of the external terminal 100 may be positioned in correspondence with each other. This increases the transmission efficiency of electric power from the coil 20 to the external terminal 100.

In such a state, the user usually holds a longitudinal end of the external terminal 100. The power receiving antenna 12 is located toward the coil 20 in the longitudinal direction of the portable charging terminal 10. Thus, the power receiving antenna 12 is located near the central part of the external terminal 100. This limits situations in which the user covers the power receiving antenna 12 with a hand.

### Detail of Antenna Elements

In the present embodiment, each circular polarized antenna element A is a circular polarized antenna configured to receive wirelessly transmitted electric power.

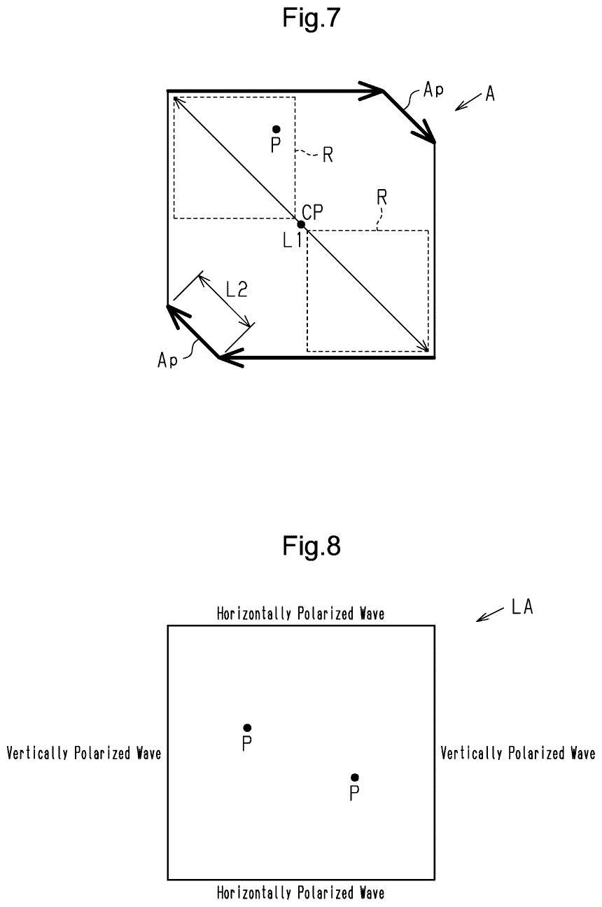

As an example of the circular polarized antenna element A, FIG. 7 shows the structure of a left-hand circular polarized antenna that generates circularly polarized waves. The circular polarized antenna element A is not limited to a left-hand circular polarized antenna shown in FIG. 7 and may be, for example, a different type of circular polarized antenna such as a circular polarized antenna that is round.

The circular polarized antenna element A shown in FIG. 7 is formed by truncating diagonal corners of a square (hereafter referred to as the perturbations Ap) to form a hexagon. A feed point P is located inside the hexagon. In FIG. 7, the perturbations A are formed in the upper right corner and the lower left corner. Impedance matching and various antenna parameters of the circular polarized antenna element A may be adjusted by changing the size of the perturbations Ap and the location of the feed point P.

In one example, the two perturbations Ap have the same size and shape and are parallel to a diagonal line L1 connecting the corners where the perturbations Ap are not formed. In this case, preferably, the perturbations Ap each have a length L2 that is between 12.6% and 14.8%, inclusive, of the length of the diagonal line L1. Preferably, the feed point P is located within a square region R having a vertex at one of the corners where the perturbation Ap is not formed and another vertex corresponding to a center point CP of the hexagon that is diagonal to the corner where the perturbation Ap is not formed.

As shown in FIG. 5, the twelve circular polarized antenna elements A1 to A12 are disposed on the first main surface 40a of the substrate 40 in columns, each including four polarized antenna elements arranged at constant intervals in the longitudinal direction, and rows, each including three polarized antenna elements arranged at constant intervals in the lateral direction. In other words, the twelve circular polarized antenna elements A1 to A12 are arranged so that there are rows of three elements arranged at intervals in the lateral direction, and columns of four elements arranged at intervals in the longitudinal direction.

Every one of the circular polarized antenna elements A1 to A12 is the circular polarized antenna element A. Among the circular polarized antenna elements A1 to A12, the circular polarized antenna elements A of the power receiving antenna 12 are the circular polarized antenna elements A1 to A4, A6, A7, and A9 to A12, and the circular polarized antenna elements A of the communication antenna 22 are the circular polarized antenna elements A5 and A8. The rectifying circuits 14a are connected to the circular polarized antenna elements A1 to A4, A6, A7, and A9 to A12 of the power receiving antenna 12. A transmitter acting as the communication unit 14d is connected to the circular polarized antenna elements A5 and A8 of the communication antenna 22.

In the present embodiment, in the first region 71 in which the circular polarized antenna elements A1 to A12 are arranged, the communication antenna 22 is formed by the two circular polarized antenna elements A that are located closest to the center of the first region 71. In other words, the antenna elements of the power receiving antenna 12 (circular polarized antenna elements A1 to A4, A6, A7, and A9 to A12) surround the antenna elements of the communication antenna 22 (circular polarized antenna elements A5 and A8).

Each circular polarized antenna element A is oriented as determined by the locations of the perturbations Ap and the location of the feed point P. As shown in FIG. 5, among the twelve circular polarized antenna elements A1 to A12, only the circular polarized antenna element A7 is oriented in a different direction. More specifically, the circular polarized antenna element A7 is oriented in a direction rotated by 180 degrees relative to the other circular polarized antenna elements A6 and A8 to A12 on the first main surface 40a of the substrate 40.

In this case, the distance is increased between the feed point P of the circular polarized antenna element A7 and the feed point P of the circular polarized antenna elements A4, which is adjacent to one side of the circular polarized antenna element A7 in the longitudinal direction. In the same manner, the distance is increased between the feed point P of the circular polarized antenna element A7 and the feed point P of the circular polarized antenna element A8, which is adjacent to one side of the circular polarized antenna element A7 in the lateral direction.

Thus, in the plan view of FIG. 6 showing the second main surface 40b of the substrate 40, a wide space S1 extends between the feed point P of the circular polarized antenna element A7 and the feed point P of the circular polarized antenna element A4 on the second main surface 40b of the substrate 40. In the same manner, a wide space S2 extends between the feed point P of the circular polarized antenna element A7 and the feed point P of the circular polarized antenna element A8. Large components (not shown) are disposed in the spaces S1 and S2 on the second main surface 40b of the substrate 40. Examples of large components include a beacon IC, a microcomputer, and a memory. FIG. 6 does not show some of the components (e.g., the charging circuit 14b and the charge control circuit 14c).

### Substrate Layer Structure

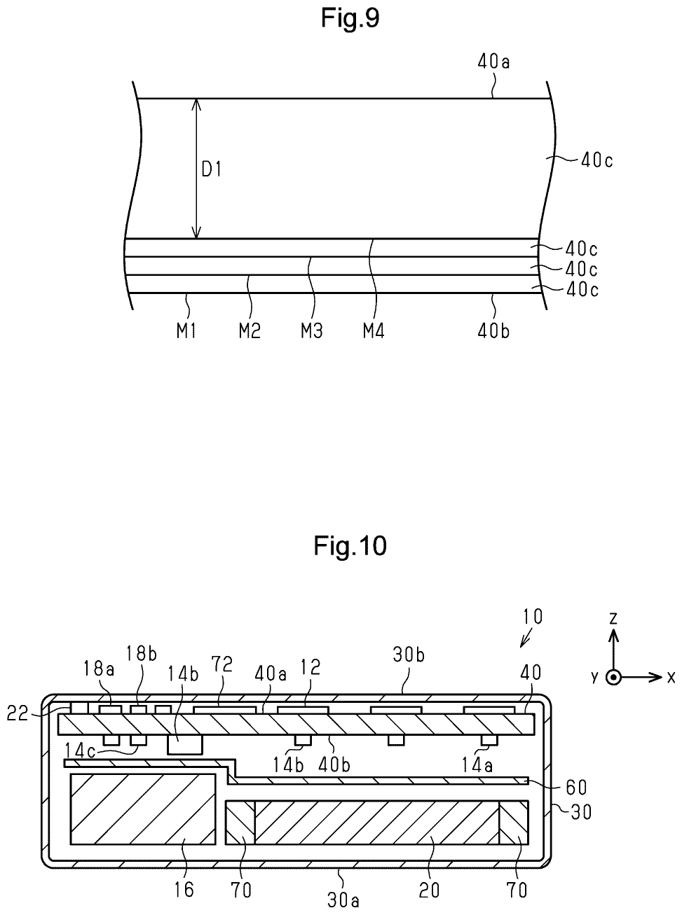

FIG. 9 is a cross-sectional view showing the first region 71 of the substrate 40. The substrate 40 includes a stack of metal layers, and insulation layers 40c arranged between the metal layers. In the example shown in FIG. 9, the substrate 40 includes four metal layers M1 to M4. The metal layer M1 is a conductive pattern formed on the second main surface 40b. The metal layer M4, which is the closest to the first main surface 40a, is GND wiring connecting the circular polarized antenna element A to a ground. The metal layers M2 and M3, which are located between the metal layer M1 and the metal layer M4, are for example, high-frequency wiring and a signal shield.

In the first region 71 of the substrate 40, distance D1 between the metal layer M4, which is closest to the first main surface 40a, and the first main surface 40a is greater than the interlayer distance of the metal layers M1 to M4. Distance D1 is, for example, 1.175 mm or greater, preferably, 1.575 mm considering the 3 dB half value angle. Further, distance D1 is, for example, 1.575 mm or less.

### Operation

The operation of the present embodiment will now be described.

With reference to FIG. 8, a linear polarized antenna element LA will now be described. The linear polarized antenna element LA shown in FIG. 8 is square. Two feed points P are located inside the square. One feed point P outputs a signal based on received vertically polarized waves, and the other feed point P outputs a signal based on received horizontally polarized waves. A hybrid coupler (not shown) is connected to the linear polarized antenna element LA. The hybrid coupler shifts the phase of a signal based on vertically polarized waves from the phase of a signal based on horizontally polarized waves, which are output from the linear polarized antenna element LA, to combine the signals. The hybrid coupler then outputs the combined signal.

In the present embodiment, the power receiving antenna 12 is formed by the circular polarized antenna element A. The circular polarized antenna element A includes a single feed point P and outputs a signal based on circularly polarized waves. The feed point P results in the radiation of circularly polarized waves, characterized by an electric field vector that rotates in a circular trajectory during propagation. The signal based on circularly polarized waves corresponds to the combined signal formed by combining a signal based on vertically polarized waves and a signal based on horizontally polarized waves. Thus, when using the circular polarized antenna element A, there is no need for the hybrid coupler that combines a signal based on vertically polarized waves and a signal based on horizontally polarized waves.

By using the circular polarized antenna element A and omitting the hybrid coupler, transmission loss that would be caused by the hybrid coupler is avoided. As a result, the antenna gain is higher than when using the linear polarized antenna element LA since there is no transmission loss that would be caused by the hybrid coupler.

### Advantages

(1) The portable charging terminal 10 includes the case 30, the power storage device 16, the charging interface (coil 20), and the substrate 40. The charging interface is configured to supply electric power from the power storage device 16 to an external terminal. The power receiving antenna 12, which is configured to receive the electric power supplied to the power storage device 16, and the power receiving circuit 14, which is configured to charge the power storage device 16 with the electric power received from the power receiving antenna 12, are disposed on the substrate 40. The power receiving antenna 12 includes the circular polarized antenna elements A.

In the above configuration, there is no hybrid coupler that would cause transmission loss. This increases the antenna gain.

(2) The circular polarized antenna elements A are disposed on the first main surface 40a of the substrate 40. The circular polarized antenna elements A are disposed on the first main surface 40a in rows, each including an n number of circular polarized antenna elements A arranged at intervals in the lateral direction, and columns, each including an m number of circular polarized antenna elements A arranged at intervals in the longitudinal direction. At least one of the circular polarized antenna elements A disposed on the first main surface 40a of the substrate 40 is oriented by 180 degrees, as determined by the perturbation Ap and the position of the feed point P, from one or both of an adjacent one the circular polarized antenna elements A in the longitudinal direction and an adjacent one of the circular polarized antenna elements A in the lateral direction.

In the above configuration, the second main surface 40b of the substrate 40 includes wide spaces S1 and S2 extending between the feed point P of the circular polarized antenna element A that is oriented in a different direction from the feed points P of the adjacent circular polarized antenna elements A. The spaces S1 and S2 are used to dispose large components in the first region 71 of the second main surface 40b. The increased space in the first region 71 allows a large number of circular polarized antenna elements A to be arranged in the first region 71. The arrangement of a large number of circular polarized antenna elements A increases the antenna gain.

(3) The portable charging terminal 10 includes the communication antenna 22 used for communication with an external device. The communication antenna 22 includes the circular polarized antenna elements A. The circular polarized antenna elements A disposed on the first main surface 40a of the substrate 40 include the circular polarized antenna elements A of the power receiving antenna 12 and the circular polarized antenna elements A of the communication antenna 22. The circular polarized antenna elements A of the communication antenna 22 reduces reading errors when an external power supplying device detects the presence of the portable charging terminal.

(4) In the first region 71 of the first main surface 40a of the substrate 40 where the circular polarized antenna elements A are disposed, the circular polarized antenna elements A5 and A8 located closest to the center of the first region 71 are the circular polarized antenna elements A of the communication antenna 22. In the above configuration, the circular polarized antenna elements A of the communication antenna 22 are located close to the center of the first region 71. This avoids a situation in which the reading direction is biased when an external power supplying device detects the presence of the portable charging terminal.

(5) The substrate 40 includes the metal layers M1 to M4 stacked in the thickness direction of the substrate 40, and the insulation layers 40c arranged between the metal layers M1 to M4. The distance D1 between the metal layer M4, which is the one closest to the first main surface 40a among the metal layers M1 to M4, and the first main surface 40a is greater than the interlayer distance of the metal layers M1 to M4. The long distance D1 between the circular polarized antenna elements A, which are disposed on the first main surface 40a, and the metal layer M4, which is arranged in the substrate 40, allows the circular polarized antenna elements A to be operated stably.

### Second Embodiment

A second embodiment will now be described with reference to the drawings focusing on differences from the first embodiment.

FIG. 10 is a cross-sectional view of the substrate 40 in the portable charging terminal 10 in accordance with the present embodiment. In FIG. 10, same reference numerals are given to those components that are the same as the corresponding components shown in FIG. 3.

Referring to FIG. 10, the portable charging terminal 10 does not include the charging substrate 50. The power conversion circuit 18a and the non-contact control circuit 18b are both disposed on the substrate 40. More specifically, the power conversion circuit 18a and the non-contact control circuit 18b are each disposed on the first main surface 40a of the substrate 40.

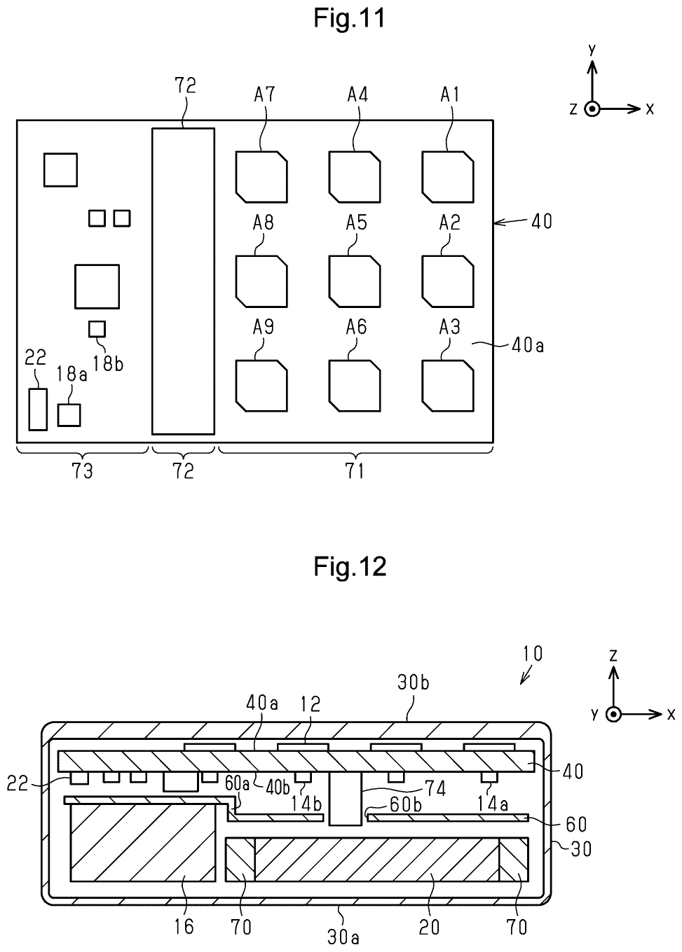

FIG. 11 is a plan view showing the first main surface 40a of the substrate 40. As shown in FIG. 7, the first main surface 40a is divided in the x-axis direction of the substrate 40, which is the longitudinal direction, into three regions, namely, the first region 71, the second region 72, and a third region 73.

The circular polarized antenna elements A are disposed in the first region 71. In the present embodiment, there are nine circular polarized antenna elements A, namely, circular polarized antenna elements A1 to A9. The circular polarized antenna elements A1 and A9 are disposed in columns, each including three polarized antenna elements A arranged at constant intervals in the longitudinal direction, and rows, each including three polarized antenna elements arranged at constant intervals in the lateral direction. Among the circular polarized antenna elements A1 to A9, the power receiving antenna 12 includes the circular polarized antenna elements A1 to A4 and A6 to A9, and the communication antenna 22 includes the circular polarized antenna element A5. In the present embodiment, in the first region 71 in which the circular polarized antenna elements A1 to A9 are disposed, the communication antenna 22 is formed by the circular polarized antenna element A that is located closest to the center of the first region 71.

The second region 72 is the GND region. The power conversion circuit 18a and the non-contact control circuit 18b are disposed in the third region 73. As shown in FIG. 12, the second region 72, which is the GND region, is located between the first region 71 and the third region 73 in the x-axis direction.

### Third Embodiment

A third embodiment will now be described with reference to the drawings focusing on differences from the first embodiment.

FIG. 12 is a cross-sectional view of the portable charging terminal 10 in accordance with the present embodiment. In FIG. 12, same reference numerals are given to those components that are the same as the corresponding components shown in FIG. 3.

Referring to FIG. 12, the portable charging terminal 10 does not include the charging substrate 50. The power conversion circuit 18a and the non-contact control circuit 18b are both disposed on the substrate 40.

A high-power component 74 is disposed on the second main surface 40b of the substrate 40. The electromagnetic shield 60 includes an opening 60b. The opening 60b is slightly larger than a cross section of the high-power component 74 taken along a plane parallel to the substrate 40. The high-power component 74 has a distal end inserted into the opening 60b.

The electromagnetic shield 60 is in contact with the power storage device 16. More specifically, the electromagnetic shield 60 is in contact with, for example, the entire surface of the power storage device 16 facing the electromagnetic shield 60. The surface of the power storage device 16 facing the electromagnetic shield 60 is insulated from the electromagnetic shield 60. Such insulation is provided by, for example, an insulation member formed on the surface of the power storage device 16 facing the electromagnetic shield 60.

In the case 30, the power receiving wall 30b has a greater thickness than the charging wall 30a. The thickness is the dimension in a direction orthogonal to the planes of the power receiving wall 30b and the charging wall 30a. The thickness is the dimension in the z-axis direction.

### Modified Examples

The above embodiments may be modified as described below. The above-described embodiments and the modified examples described below may be combined as long as there is no technical contradiction.

The circular polarized antenna element A may be a right-hand circular polarized antenna.

The layout of the circular polarized antenna elements A on the first main surface 40a of the substrate 40 is not limited to the layouts described in the above embodiments. For example, there may be rows of four or more circular polarized antenna elements A arranged in the lateral direction and four or more circular polarized antenna elements A arranged in the vertical direction. In other words, the circular polarized antenna elements A may be disposed in rows, each including an n number of circular polarized antenna elements A arranged at intervals in the lateral direction, and columns, each including an m number of circular polarized antenna elements A arranged at intervals in the longitudinal direction. Here, m and n are integers greater than or equal to three, and may be equal or unequal to each other. Further, the circular polarized antenna elements A may be arranged in a zigzagged manner in the longitudinal and lateral directions or may be arranged at random.

Among the circular polarized antenna elements A disposed on the first main surface 40a of the substrate 40, there is no particular limitation to the number of the circular polarized antenna elements A oriented in a different direction. For example, there may be two or more of such circular polarized antenna elements A. Further, there is no particular limitation to where the circular polarized antenna element A oriented in a different direction is disposed. For example, the circular polarized antenna element A disposed at a corner portions may be oriented in a different direction. Alternatively, the circular polarized antenna elements A may all be oriented in the same direction.

The communication antenna 22 does not have to be applied to have the portable charging terminal 10 function as a beacon.

Any one of the circular polarized antenna elements A disposed on the first main surface 40a of the substrate 40 may be used for the communication antenna 22.

The circular polarized antenna elements A disposed on the first main surface 40a of the substrate 40 may all be used for the power receiving antenna 12. In this case, an antenna element of the communication antenna 22 is preferably disposed at another portion. Examples of the other portions include, for example, the charging substrate 50 and the second main surface 40b of the substrate 40.

The antenna element of the communication antenna 22 may be the linear polarized antenna element LA.

The layer structure of the substrate 40 is not limited to the structure of the above embodiments. For example, the distance D1 between the metal layer M4, which is closest to the first main surface 40a, and the first main surface 40a may be less than or equal to the interlayer distance of the metal layers M1 to M4.

The charging interface is not limited to the coil 20. For example, the portable charging terminal 10 may supply electric power through a wire connection to the external terminal 100, and the charging interface may be a device that supplies the electric power through the wire connection. The charging interface may include both the coil 20 and the device that supplies electric power through wire connection. In this case, for example, when the device that supplies electric power through wire connection is a circuit disposed on a substrate, the coil 20 of the charging interface may be the only member arranged facing the charging wall 30a.

The above embodiments illustrate examples in which the power conversion circuit 18a and the non-contact control circuit 18b are disposed on the surface of the charging substrate 50 facing the substrate 40. This, however, is not a limitation. For example, at least one of the power conversion circuit 18a and the non-contact control circuit 18b may be arranged on the surface of the substrate 40 at the side opposite the charging substrate 50.

The longitudinal dimension of the charging substrate 50 does not have to be shorter than that of the substrate 40. For example, the power storage device 16 may be thin. Thus, the electromagnetic shield 60 may be arranged facing the charging substrate 50 and the electromagnetic shield 60 and does not have to include the bent portion 60a. In this case, the end of the substrate 40 at the negative side in the x-axis direction also sandwiches the charging substrate 50 with the electromagnetic shield 60.

The size of the electromagnetic shield 60 may be changed. For example, the size of the electromagnetic shield 60 may be set so that the x-axis coordinate components and the y-axis coordinate components of the substrate 40 are within the x-axis coordinate components and the y-axis coordinate components of the electromagnetic shield 60.

The planes of the power receiving wall 30b and the charging wall 30a having sides parallel to the x-axis and the y-axis do not have to be rectangular. For example, the planes may be square. In each of the above embodiments, the power receiving wall 30b may be thicker than the charging wall 30a or thinner than the charging wall 30a.

The members disposed on the second main surface 40b in the region onto which the circular polarized antenna elements A are projected at a right angle are not limited to the rectifying circuits 14a. For example, the charging circuit 14b may be disposed in the region onto which the circular polarized antenna elements A are projected at a right angle. Further, for example, the members disposed in the region onto which the circular polarized antenna elements A are projected at a right angle may be both the rectifying circuits 14a and the charging circuit 14b.

The magnet does not have to be arranged facing the charging wall 30a. For example, electric power may be supplied to the external terminal 100 through wire connection, and the magnet may be arranged facing the power receiving wall 30b.

### CLAUSES

Technical concepts that can be understood from each of the above embodiments and modified examples will now be described.

1. A portable charging terminal, including:
a case;
a power storage device; a charging interface; and
a substrate, where
the case includes a power receiving wall and a charging wall,
the power receiving wall and the charging wall define two planes of the case that face each other,
the charging interface is configured to supply electric power from the power storage device to an external terminal,
a power receiving antenna disposed on the substrate is configured to receive electric power supplied to the power storage device,
the power storage device and the charging interface are arranged facing the charging wall,
the power storage device and the charging interface are arranged facing the charging wall, and
the substrate is arranged so that the power receiving antenna faces the power receiving wall.

With this configuration, the power storage device is charged with the electric power received by the power receiving antenna. This allows sufficient electric power to be supplied to an external device without increasing the capacity of the power storage device. The power storage device, which is reduced in size, and the charging interface are arranged facing the charging wall of the case. This allows the portable charging device to be thinner than when the power storage device and the charging interface are arranged one above the other.

2. The portable charging device according to clause 1, further including a power receiving circuit disposed on the substrate and configured to charge the power storage device with electric power from the power receiving antenna.

Clause 2 corresponds to a configuration in which the rectifying circuits 14a, the charging circuit 14b, the charge control circuit 14c, and the communication unit 14d are disposed on the substrate 40. In the above configuration, the power receiving antenna and the power receiving circuit are disposed on the same substrate. This allows the portable charging terminal to be reduced in size more easily than when the power receiving antenna and the power receiving circuit are disposed on different substrates.

3. The portable charging terminal according to clause 1 or 2, where
the power receiving wall and the charging wall of the case define rectangular planes,
the power charging device and the charging interface are arranged in a longitudinal direction of the plane of the charging wall,
the substrate includes a region onto which the power storage device is projected at a right angle and a region onto which the charging interface is projected at a right angle, and
the power receiving antenna is disposed on the substrate in the region onto which the charging interface is projected at a right angle.

In the above configuration, the power receiving antenna is disposed in the case toward one side in the longitudinal direction. This limits situations in which the power receiving antenna is blocked by a user's hand. In particular, the part where the charging interface is located is not likely to be held by the user. Since the power receiving antenna is disposed toward one side of the substrate in the region onto which the charging interface is projected at a right angle, the power receiving antenna is less likely to be blocked by the user's hand. This avoids a situation in which the electric power supplied from an external device is attenuated by the user's hand before reaching the power receiving antenna.

The longitudinal direction corresponds to the x-axis direction. The region in the substrate onto which the power storage device 16 is projected at a right angle corresponds to a region in which the x-axis coordinate components and the y-axis coordinate components of the substrate 40 are the same as the x-axis coordinate components and the y-axis coordinate components of the power storage device 16. The region in the substrate onto which the charging interface is projected corresponds to a region in which the x-axis coordinate components and the y-axis coordinate components of the substrate 40 are the same as the x-axis coordinate components and the y-axis coordinate components of the coil 20.

4. The portable charging terminal according to any one of clause 1 to 3, where
the charging interface is a non-contact charging coil,
the portable charging terminal further includes an electromagnetic shield, and
the power storage device and the charging interface are arranged sandwiching the electromagnetic shield with the substrate.

Clause 4 corresponds to a configuration in which the power storage device 16 and the coil 20 are arranged sandwiching the electromagnetic shield 60 with the substrate 40 in the z-axis direction. In the above configuration, the electromagnetic shield limits the effect that the electromagnetic field produced by the charging interface has on the substrate.

5. The portable charging terminal according to clause 4, where a distance from a region of the substrate where the power receiving antenna is formed to the electromagnetic shield is greater than a distance from a region of the substrate where the power receiving antenna is not formed to the electromagnetic shield.

Clause 5 corresponds to a configuration in which the z-axis coordinate of the electromagnetic shield 60 at the positive x-axis direction side of the bent portion 60a is smaller than the z-axis coordinate of the electromagnetic shield 60 at the negative x-axis direction side of the bent portion 60a. In the above configuration, in contrast with when the distance is fixed between the substrate and the electromagnetic shield, the distance between the power receiving antenna and the electromagnetic shield can be maximized while reducing the thickness of the case. This readily increases the performance of the power receiving antenna while reducing the thickness of the case.

6. The portable charging terminal according to clause 4 or 5, where the power storage device and the electromagnetic shield are in contact with each other.

The configuration of clause 6 corresponds to the third embodiment.

In the above configuration, heat is dissipated efficiently from the power storage device by the electromagnetic shield.

7. The portable charging terminal according to any one of clauses 4 to 6, where the electromagnetic shield includes an opening, and a predetermined component disposed on the substrate is inserted into the opening of the electromagnetic shield.

In the above configuration, in contrast with when the predetermined component faces the electromagnetic shield, the thickness of the case can be reduced. Thus, the thickness of the case can be reduced without affecting the performance of the electromagnetic shield. The predetermined component corresponds to the high-power component 74.

8. The portable charging terminal according to clause 2, where
the substrate includes a first main surface and an opposite second main surface,
the first main surface faces the power receiving wall,
the power receiving antenna is disposed on the first main surface of the substrate,
the portable charging terminal further includes a power receiving circuit,
the power receiving circuit is disposed on the substrate and configured to charge the power storage device with electric power received by the power receiving antenna, and
at least part of the power receiving circuit is disposed on the second main surface.

Clause 8 corresponds to a configuration in which the rectifying circuits 14a are disposed on the second main surface 40b in the region onto which the power receiving antennas 12 are projected at a right angle.

In the above configuration, in contrast with when the at least part of the power receiving circuit is disposed on the first main surface, the at least part of the power receiving circuit is disposed at a further inward part of the case. Thus, in contrast with when the at least part of the power receiving circuit is disposed on the first main surface, the at least part of the power receiving circuit can be protected from external impacts.

9. The portable charging terminal according to clause 8, where
the power receiving circuit includes a rectifying circuit and a charging circuit,
the rectifying circuit rectifies AC electric power received by the power receiving antenna,
the charging circuit charges the power storage device with an output of the rectifying circuit, and
the rectifying circuit is disposed on the second main surface in a region onto which the power receiving antenna is projected at a right angle.

Clause 9 corresponds to a configuration in which the rectifying circuits 14a are disposed on the second main surface 40b in a region onto which the power receiving antennas 12 are projected at a right angle.

The AC electric power received by the power receiving antenna is converted into DC electric power by the rectifying circuit. Thus, by disposing the power receiving antenna and the rectifying circuit on opposite sides of the substrate, the electrical path between the power receiving antenna and the rectifying circuit may be shortened.

10. The portable charging terminal according to any one of clauses 1 to 9, further including a communication antenna used for communication with an external device, where
the substrate is rectangular, and
the communication antenna is disposed on the substrate close to an end in a longitudinal direction at a side opposite to a side where the power receiving antenna is disposed.

In the above configuration, the communication antenna is disposed on the substrate close to an end in the longitudinal direction. Thus, in comparison with when the communication antenna is disposed in a longitudinally central part of the substrate, the communication antenna is less likely to blocked by the user's hand. This avoids a situation in which radio waves received by the communication antenna are excessively attenuated. The longitudinal direction corresponds to the x-axis direction. The end at the opposite side corresponds to the end of the substrate 40 at the negative side in the x-axis direction.

11. The portable charging terminal according to any one of clauses 1 to 10, where
the substrate includes a first main surface and an opposite second main surface,
the first main surface faces the power receiving wall, the power receiving antenna is disposed on the first main surface of the substrate, and
among components disposed on the substrate, the one having the greatest projection amount from the substrate is disposed on the second main surface.

The power receiving antenna and the ground of the power receiving antenna are projected by a relatively small amount from the power receiving antenna. The power receiving antenna can be formed on the first main surface because of the relatively small projection amount from the first main surface. Since the component having the greatest projection amount is disposed on the second main surface, the distance between the first main surface and the power receiving wall can be decreased. This allows the space between the substrate and the charging wall to be increased while reducing the thickness of the portable charging terminal. The component having the greatest projection amount corresponds to the charging circuit 14b in the first and second embodiments and corresponds to the high-power component 74 in the third embodiment.

12. The portable charging terminal according to any one of clauses 1 to 11, where
the power receiving antenna is a microstrip antenna, and
a ground of the power receiving antenna is disposed on the substrate between a region where a circuit component is disposed and a region where the power receiving antenna is disposed.

In the above configuration, the ground of the power receiving antenna is disposed on the substrate between the region where the circuit component is disposed and the region where the power receiving antenna is disposed. This increases the power receiving efficiency of the power receiving antenna. The ground corresponds to the second region 72, which is the GND region.

13. The portable charging terminal according to any one of clauses 1 to 12, where components other than the power receiving antenna that are disposed on a surface of the substrate opposite to a surface on which the power receiving antenna is disposed is greater in number than components other than the power receiving antenna that are disposed on the surface of the substrate on which the power receiving antenna is disposed.

Clause 13 corresponds to a configuration in which electronic components other than the circular polarized antenna elements A are disposed on the second main surface 40b in the first embodiment and the third embodiment.

In the above configuration, more space can be provided on the surface on which the power receiving antenna is disposed compared to when the components other than the power receiving antenna disposed on the surface on which the power receiving antenna is disposed is greater in number than the components other than the power receiving antenna disposed on the surface opposite to the surface on which the power receiving antenna is disposed. This ensures that space is provided for a ground of the power receiving antenna on the surface on which the power receiving antenna is disposed.

14. The portable charging terminal according to any one of clauses 1 to 13, where
the charging interface includes a coil configured to perform non-contact charging,
the portable charging terminal further includes a power receiving circuit and a non-contact charging circuit,
the power receiving circuit is configured to charge the power storage device with electric power from the power receiving antenna, the non-contact charging circuit is configured to supply electric power of the power storage device to an external device through the charging interface, and
the power receiving circuit and the non-contact charging circuit are disposed on the substrate.

Clause 14 corresponds to the second embodiment and the third embodiment.

In the above configuration, the power receiving circuit and the non-contact charging circuit are disposed on the same substrate. Thus, the portable charging terminal has less substrates than when the power receiving circuit and the non-contact charging circuit are disposed on different substrates. This allows costs to be reduced in comparison with when the power receiving circuit and the non-contact charging circuit are disposed on different substrates.

15. The portable charging terminal according to any one of clauses 1 to 14, where
a magnet is arranged facing the charging wall and used to fix the portable charging terminal to a subject supplied with electric power of the power storage device, and
a part of the case forming the power receiving wall is thicker than a part of the case forming the charging wall.

Clause 15 corresponds to the third embodiment.

In the above configuration, the charging wall is thinner than the power receiving wall. This ensures than the magnet fixes the portable charging terminal to the subject supplied with electric power as compared with when the charging wall and the power receiving wall have the same thickness. Further, the power receiving wall that is thicker than the charging wall further ensures protection of the components disposed on the substrate in comparison with when the thickness of the power receiving wall is less than or equal to the thickness of the charging wall.

16. A portable charging terminal, including:
a case;
a power storage device;
a charging interface; and
a substrate, where
the charging interface is configured to supply electric power from the power storage device to an external terminal,
a power receiving antenna disposed on the substrate is configured to receive electric power supplied to the power storage device,
a power receiving circuit disposed on the substrate is configured to charge the power storage device with electric power from the power receiving antenna, and
the power receiving antenna includes a circular polarized antenna element.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A portable charging terminal, comprising:
a case;
a power storage device;
a charging interface; and
a substrate, wherein
the case includes a power receiving wall and a charging wall,
the power receiving wall and the charging wall define two planes of the case that face each other,
the charging interface is configured to supply electric power from the power storage device to an external terminal,
a power receiving antenna disposed on the substrate is configured to receive electric power supplied to the power storage device, and a power receiving circuit disposed on the substrate is configured to charge the power storage device with electric power from the power receiving antenna,
the power storage device and the charging interface are arranged facing the charging wall,
the substrate is arranged so that the power receiving antenna faces the power receiving wall, and
the power receiving antenna includes a circular polarized antenna element.

2. The portable charging terminal according to claim 1, wherein
the circular polarized antenna is one of multiple circular polarized antenna elements disposed on a first main surface of the substrate, and
the multiple circular polarized antenna elements are disposed on the first main surface in rows, each including an n number of circular polarized antenna elements arranged at intervals in a lateral direction, and columns, each including an m number of circular polarized antenna elements arranged at intervals in a longitudinal direction, where m and n are integers greater than or equal to three, and m and n are equal to or unequal to each other.

3. The portable charging device according to claim 2, wherein at least one of the multiple circular polarized antenna elements disposed on the first main surface of the substrate is oriented by 180 degrees, as determined by locations of a perturbation and a feed point, from one or both of an adjacent one of the circular polarized antenna elements in the longitudinal direction and an adjacent one of the circular polarized antenna elements in the lateral direction.

4. The portable charging terminal according to claim 2, further comprising:
a communication antenna used for communication with an external device, wherein
the communication antenna includes a circular polarized antenna element, and
the multiple circular polarized antenna elements arranged on the first main surface of the substrate includes the circular polarized antenna element of the power receiving antenna and the circular polarized antenna element of the communication antenna.

5. The portable charging terminal according to claim 4, in a region of the first main surface of the substrate where the multiple circular polarized antenna elements are disposed, at least one of the multiple circular polarized antenna elements located closest to a center of the region is the circular polarized antenna element of the communication antenna.

6. The portable charging terminal according to claim 1, wherein
the substrate includes metal layers stacked in a thickness direction of the substrate, and an insulation layer arranged between the metal layers, and
a distance between the first main surface and one of the metal layers that is closest to the first main surface is greater than a distance between the metal layers.
